(19) United States
(12) Patent Application Publication
(10) Pub. No.: US 2023/0083984 A1
(43) Pub. Date: Mar. 16, 2023

(54) POST POSITION VIDEO BOARD

(71) Applicants: Jonathan Douglas, Dover, DE (US); NEVCO SPORTS, LLC, Greenville, IL (US)

(72) Inventor: Jonathan Douglas, Dover, DE (US)

(21) Appl. No.: 17/866,993

(22) Filed: Jul. 18, 2022

Related U.S. Application Data
(60) Provisional application No. 63/244,500, filed on Sep. 15, 2021.

(51) Int. Cl. G07F 17/32; A63K 3/02

(52) U.S. Cl. CPC G07F 17/3211; G07F 17/3288; A63K 3/026

(57) ABSTRACT

An apparatus and a method of use thereof for digitally displaying post position numbers above stalls in a game of horse racing. The apparatus includes an array of panels, each panel includes a housing configured to mount to a supporting structure of a stall and an electronic display coupled to the housing. The array of panels can mount such that the electronic displays of the array panels are continuous. Post position numbers can be received remotely through a remote control and can be displayed for each gate.

### CROSS-REFERENCE TO RELATED APPLICATIONS

This application claims priority from a U.S. Provisional Patent Appl. No. 63/244,500 filed on Sep. 15, 2021, which is incorporated herein by reference in its entirety.

### FIELD OF INVENTION

The present invention relates to a display board for listing post position numbers, and more particularly, the present invention relates to an electronic display board for post position numbers and advertisements.

### BACKGROUND

Post position numbers are used in horse racing to indicate the location or gate from which the horse starts. For an eight-horse race, the post position numbers range from 1-8. The post position numbers are made of metal, plastic, or wood. The post position numbers are shown on printed posters, boards, and the like. The printed post position numbers have several limitations, such as they are fixed. The post position numbers have to be manually moved by hand for each race at every racetrack. The assistant starter must climb up into the gate, reach up, and affix the post position number to the gate. This can be dangerous as the starter is balancing his or herself on small strips of metal inside the stall. Besides being risky, manual changing of the post position number is laborious and time-consuming. The visibility of the printed numbers is another drawback. The printed numbers are also monotonous and boring in appearance. The space where the post position numbers are displayed is very much unutilized.

Thus, a need is appreciated for a novel display system for post position numbers that is devoid of the aforesaid drawbacks.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for displaying post position numbers.

It is another object of the present invention that the post position numbers can be modified easily and quickly without significant physical efforts.

It is still another object of the present invention that the post position numbers appear aesthetic in appearance.

It is a further object of the present invention that the space for displaying the post position numbers can be well utilized.

It is yet another object of the present invention that the post position numbers are visible in dark.

In one aspect, disclosed is an apparatus and a method for digitally displaying post position numbers above stalls in a game of horse racing, the apparatus comprises a plurality of panels, each panel comprises a housing configured to mount to a supporting structure of a stall; and an electronic display coupled to the housing, wherein the plurality of panels are configured such that when the plurality of panels are mounted, the displays of the plurality of panels are continuous. Wherein, each panel further comprises a control unit, the control unit has a video processing unit, the control unit configured to digitally present a post position number on the respective display, wherein the control units of the plurality of panels are coupled to a common control unit. The apparatus further comprises remote control operably coupled to the common control unit, wherein the remote control configured to receive post position numbers for each of the plurality of panels. The remote control is configured to receive a modification in the post position numbers. Display is LED. The control unit is configured to change a background of the respective panel and animate the respective post position number.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is an environmental view of the apparatus shown mounted to a stall, according to an exemplary embodiment of the present invention.

FIG. 2 is a block diagram illustrating an architecture of the apparatus, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is an apparatus that can digitally display the Post Position numbers above the corresponding starting stalls in horse racing and at the same time provide digital advertising space. The apparatus includes multiple panels that can be combined to give an appearance of a continuous single display. Each panel can be controlled individually. Each panel includes a housing and a display mounted to the housing. The display can be an LCD; however, any other suitable display is within the scope of the present invention. The housing can encase the circuitry for powering and controlling the display. Although the display of each panel can be controlled individually, the content can be synchronized between the multiple displays of multiple panels. For example, a graphic can be presented that moves right to left across multiple panels connected in a series, wherein the graphic appears to move smoothly without any disruptions. The position of each panel can correspond to the position of the respective gate, such that the number displayed can be easily and without any doubts related to the respective gate.

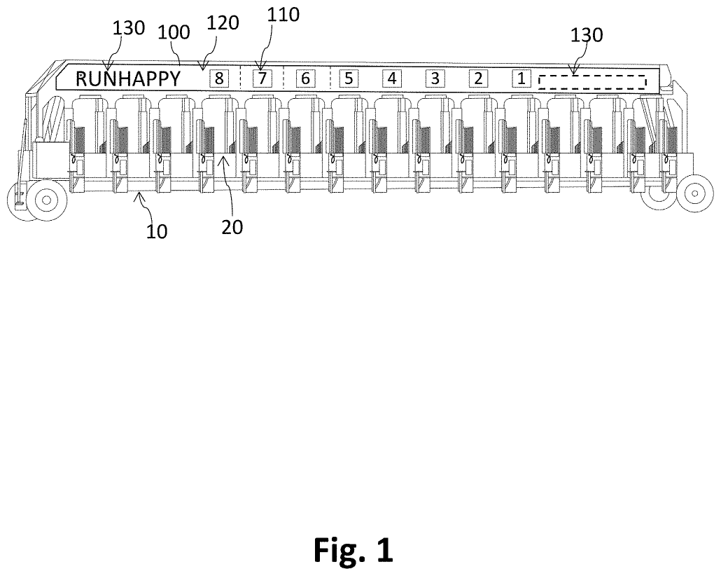

Referring to FIG. 1 shows the disclosed apparatus 100 mounted at the top positions of the stalls 10. The apparatus appears to have a continuous display that extends horizontally along the length of the stalls. The position of each panel 110 can correspond to the position of the respective gate 20, such that the number 120 displayed can be easily and without any doubt related to the respective gate 20. Each panel can have a separate control unit through which the desired number can be presented on the display of the panel. The control units of different panels can be connected to a common control unit that allows a single user to easily manage the content on different panels and synchronize the content between different panels. The user can be provided with a remote control that can be connected to the common control unit. Using the remote control, the user can display the desired number on any desired panel. Similarly, the user can put dynamic and static advertisements on the apparatus. Dynamic advertisements can run on a single panel or more than one panel. The user can control how such dynamic advertisements can be presented by feeding suitable instructions. The remote control can be any computing device and includes a smartphone, a laptop, a tablet computer, a desktop, and the like. Moreover, different functions can be programmed using more than one remote control. For example, details of advertisements and post position numbers can be set using a laptop while the post position numbers can be changed using a smartphone. The remote control can connect to the control unit through a wired network, a wireless network, or a combination of wired and wireless networks.

In one implementation, each panel can be made from several LEDs, for example, fourteen LEDs can be used for each panel. Each panel can be about 3-4 feet wide by 2-3 feet tall which would make the entire display about 44-45 feet wide and 2-3 feet tall.

Each panel can have a twist-lock water-tight connection for both power and signal cables that daisy chain from one panel to the next. The power cables are limited to daisy-chaining a maximum of three panels together per circuit. Power is fed from one or two batteries through an inverter and to a sub-panel. From the sub-panel, individual circuits are fed to the LED panels. A single battery can operate the LED display continuously for about 2 hours. Two batteries can operate the same LED display continuously for 4 hours. The batteries can be recharged after use. It is obvious, however, that the disclosed apparatus can be powered by any other power supply means, such as directly from the main power supply using an AC to DC adaptor. Moreover, the capacity and number of batteries can be varied without departing from the scope of the present invention. The signal cables are daisy-chained from the first panel to the last panel, and there can be an ethernet cable or similar cable that connects the control units of different panels. The control unit can contain suitable video processors to convert digital signals to signals that can be displayed.

In one implementation, the video output can be set up to display an image across the entire display or as split up, however, the user chooses. The user herein refers to any person who puts or wishes to put any content on the disclosed apparatus for display and includes a person operating or wishing to operate the disclosed apparatus.

In one implementation, the video display of the panels can be driven by a Nevco One player hardware device with an HDMI video output to the LED display controller. The ONE Player hardware can be running proprietary Nevco ONE software which renders the live sport, scoring, and advertising data which is provided by the Nevco ONE Controller software. The Nevco ONE Controller software can be running on either the proprietary Nevco ONE Touchscreen Controller hardware, which includes the added benefit of extreme long-range wireless technology, or any Wi-Fi-enabled consumer mobile phone, tablet, laptop, or PC. The Controller software's touch-driven user interface will present a control button for each lane of the starting gate, and the ability to either clear the lane (which can render as simply black/blank/off on the video display) or to select a horse number and an optional letter designator. A live data rendering overlay will define which LED display panels/pixels correspond to each starting gate lane location, such that each of the starting lane labels set in the controller app will get rendered above the appropriate starting gate lane. Any video display area not actively used for labeling a starting gate lane can be used for a running loop of digital advertising content. When the event is complete or no event is active, the controller application will allow the entire video display area to be blanked/blacked or to render a playlist of pre-defined advertising content. Digital advertising content is uploaded and controlled from a cloud account and automatically downloaded to the Nevco ONE Player device for rendering on the display.

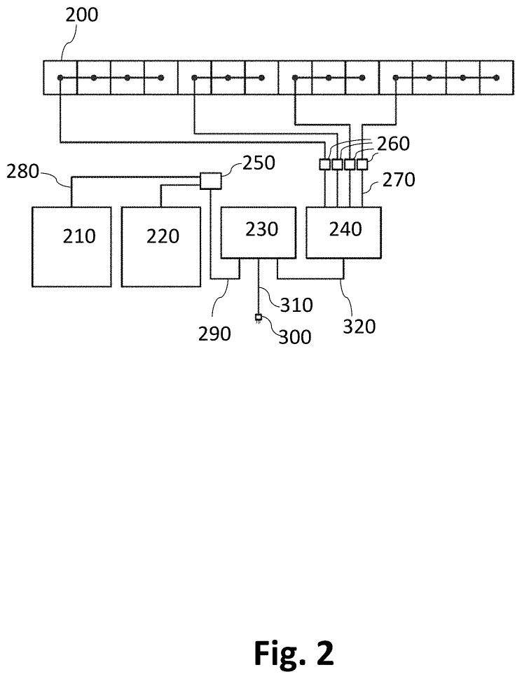

Referring to FIG. 2 which is a block diagram illustrating architecture of an implementation of the disclosed apparatus.
200 LED Video Display, 10 mm, 44.09 feet in Width and 2.1 feet in height
210 Battery, 48 V, 300 AH, (15 KWH)
220 Battery, 48 V, 300 AH,
230 Power Inverter, 12 kW, 240 VAC Input, 120 VAC Output
240 Breaker Panel, 100 A, 120 VAC, 1 Phase 60 A Main Breaker
250 Parallel Bus Bar (Battery Combiner)
260 Junction Box, 4×4
270 SOOW Cable, 10/3
280 Ring Terminal, 18 inches 6 AWG
290 Ring Terminal, 36 inches, 2 AWG
300 NEMA 6-20 P (240 VAC), to recharge batteries
310 SOOW Cable, 10/3
320 SOOW Cable, 4/2 (60 A, 120 V Inverter Output)

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for digitally displaying post position numbers above stalls in a game of horse racing, the apparatus comprises:
a plurality of panels, each panel of the plurality of panels comprises:
a housing configured to mount to a supporting structure of a stall; and
an electronic display coupled to the housing,
wherein the plurality of panels are configured such that when the plurality of panels are mounted, the electronic displays of the plurality of panels are continuous.

2. The apparatus according to claim 1, wherein each panel further comprises:
a control unit, the control unit has a video processing unit, the control unit configured to digitally present a post position number on the respective electronic display,
wherein the control units of the plurality of panels are coupled to a common control unit.

3. The apparatus according to claim 2, wherein the apparatus further comprises:
a remote control operably coupled to the common control unit, wherein the remote control is configured to receive post position numbers for each of the plurality of panels.

4. The apparatus according to claim 3, wherein the remote control is configured to receive a modification in the post position numbers.

5. The apparatus according to claim 1, wherein display is LED.

6. The apparatus according to claim 2, wherein the control unit is configured to:
change a background of the respective panel, and
animate the respective post position number.

7. A method for digitally displaying post position numbers above stalls in a game of horse racing, the method comprises:
providing an apparatus comprises:
a plurality of panels, each panel of the plurality of panels comprises:
a housing configured to mount to a supporting structure of a stall, and
an electronic display coupled to the housing,
wherein the plurality of panels are configured to be mounted such that the electronic displays of the plurality of panels are continuous.

8. The method according to claim 7, wherein each panel further comprises:
a control unit, the control unit has a video processing unit, the control unit is configured to digitally present a post position number on the respective electronic display,
wherein the control units of the plurality of panels are coupled to a common control unit.

9. The method according to claim 8, wherein the apparatus further comprises:
a remote control operably coupled to the common control unit, wherein the remote control is configured to receive post position numbers for each of the plurality of panels.

10. The method according to claim 9, wherein the remote control is configured to receive a modification in the post position numbers.

11. The method according to claim 7, wherein display is LED.

12. The method according to claim 10, wherein the control unit is configured to:
change a background of the respective panel, and
animate the respective post position number.
